(19) United States
(12) Patent Application Publication
(10) Pub. No.: US 2013/0085811 A1
(43) Pub. Date: Apr. 4, 2013

(54) WORK PRODUCT TRANSPARENCY

(71) Applicant: Scott Darden, Arcadia, CA (US)

(72) Inventor: Scott Darden, Arcadia, CA (US)

(21) Appl. No.: 13/249,088

(22) Filed: Sep. 29, 2011

(51) Int. Cl. G06Q 10/00

(52) U.S. Cl. 705/7.38

(57) ABSTRACT

A system and method to increase the transparency of electronic work product created by one or more workers. The system and method consists of a development environment for each worker, wherein the environment records work being done along with appropriate metadata. The method provides and management tools to facilitate easy access and analysis of this data. The invention further generates work related event streams, which contain summaries of worker changes of particular interest to a given supervisor. These event streams are generated by the system and sent to the supervisor in real time, or almost real time, in the form of easy to read messages that can quickly let the supervisor see work progress at a glance.

### BACKGROUND OF THE INVENTION

1. Field of the Invention

This invention relates generally to methods and system for monitoring and auditing work done on electronic documents or projects.

2. Description of the Related Art

There has always been a need to coordinate worker activity on projects, see who is doing what, who is performing, and who is not performing. In past generations, supervisors could simply look out into an office and see directly if their various employees (workers) were diligently working or not. However modern workplaces are more decentralized, and these direct observation methods are generally no longer feasible. At the same time, other methods of monitoring worker productivity, such as monitoring the final work product, have also become more complex. Different work tasks and projects can vary widely in complexity, and the supervisor may not be able to easily judge by the final work product if the worker has been fully engaged in the project or not.

In some situations, such as collaborative group efforts, exemplified by open source software development, a team of peers may also need to coordinate their efforts and monitor the activities of the other worker/collaborators. Consider for example, a complex software project with many different software modules. A collaborator working on one software module, which is known to be highly dependent on another software module, will often find it to be of his or her advantage to be rapidly informed whenever another collaborator has made changes in that other software module.

Thus there is a need for various methods of monitoring document modifications in a work group setting, particularly for group projects involving one or more electronic documents. Here, for simplicity, the person interested in getting information as to the activities of others will be called the “supervisor” or “manager”, while the person who, at a particular moment in time is editing or somehow changing the status of various project electronic documents will be called the “worker”. This word usage is not otherwise intended to convey an actual reporting relationship, and indeed the same person at various times in a project may act as both a worker and as a supervisor/manager.

Currently existing computer work monitoring applications can be used for monitoring a wide variety of worker or computer user activities. These can include reading mail written by a user, viewing web sites visited by a user, monitoring programs used by a user, recording a user's keystrokes, logging inactivity timeouts, saving user activity logs, logging one or both sides of a user's chats or instant message conversations, recording changes made to a hard drive, storing lists of created files and directories, storing lists of deleted files and directories, and capturing information through screen shots. Existing computer work monitoring applications also provide access to remote computers and allow administrators to shut down, restart, logoff, and message or freeze a single user or all users on a network.

Prior art in the area of computer work monitoring software applications includes Truong et. al., “Remote editor system”, U.S. Pat. No. 6,151,609; Nakano, et. al., “System and method for website development”, U.S. Pat. No. 6,505,212; and Horikiri et. al., “Project management system”, U.S. Pat. No. 7,257,768. Other work includes McFarlane et. al., “Employee online activity monitoring system”, US patent application 2002/0111887; Zuckerberg, et. al., “System and method for dynamically providing a news feed about a user of a social network”, US patent application 2008/0040673; and, Tsatalos et. al, “Virtual Office Environment”, US patent application 2006/0284838 (assigned to ODesk Corporation); and Tsatalos et. al., “Virtual Office Environment”, US patent application 2010/0299180.

The drawback of many of these prior art computerized work applications is that they are intrusive, and often allow the personal non-work activity of a worker to be invaded by a supervisor or manager.

For example, the remote staffing website oDesk.com utilizes a software monitoring system that is designed to allow supervisors to remotely see if their contract workers are working diligently or not. This monitoring system can, either periodically or randomly, take time-stamped screenshots of the entire screen of the worker's computer. The ODesk system then sends these screenshots to the remote supervisor. If the remote supervisor sees that the contract worker has been billing for time while, for example, a video game application is running in one corner of the worker's computer screen, then the supervisor can complain and potentially reduce the fee paid to the worker accordingly. The system is highly intrusive, can accidentally capture confidential worker information, and many workers find this type of system to be highly objectionable. At the same time, the system is also inefficient because the supervisor has to wade through huge amounts of irrelevant information in order to find a “slacking” worker.

Thus prior art work monitoring systems suffer from a lack of efficiency in organizing the work flow information in a way that provides insight into how productive a developer/worker really is. In particular, many prior art work monitoring systems record too much non-pertinent information, making it difficult for a supervisor to analyze worker performance.

### BRIEF SUMMARY OF THE INVENTION

As previously discussed, prior art systems do not provide a development environment which gives a supervisor/manager full transparency for all electronic work product created in regards to his or her document or project.

The invention is based, in part, on the insight that what is needed is a work monitoring system or “work product transparency system”, that is oriented toward electronic documents, and which improves on prior art work monitoring systems by facilitating easy and effective supervisor monitoring of projects (e.g. electronic document creation or modification projects), while on the other hand minimizing the burden and obtrusiveness of the system on the worker.

In one embodiment, the invention provides a means to a) visualize the number of changes made to a document or project in time; b) allow a manager to see the document or project at any point in its history; c) watch current work being performed on any document; d) get a summary of work done in a report for a particular period of time; and e) allow a manager to view an associated event feed. This associated event feed feature can be particularly valuable, because it allows a supervisor to see key work in progress events at a glance.

More specifically, in some embodiments, the invention may be a method or software product (e.g. work product transparency software) to operate a computerized server-client system to monitor worker production or modification of one or more electronic document files or project files. These files are usually stored in a server accessible database. Here at least one worker usually identified with his or her own worker identification (ID) “tag” or “data”, will login to the server using the worker's remote client computer, and begin editing the project file(s).

The invention's worker transparency software, running primarily on the server, but also in part on the worker's client computer (computerized device), intercepts or is sent the worker's edit operation data. The worker transparency software saves this edit operation data, along with the worker's ID data and an edit timestamp, on the server. This produces various files containing edit history data.

According to the invention, either automatically (e.g. on a new event or every “x” hours or days), or upon receiving a query from a supervisor, the worker transparency software retrieves the edit history data, and performs various analytical operations upon this edit history data. For example, the invention can analyze the data (e.g. do statistical analysis on the data, create plots from the data, and use the data to reproduce the status of various project documents at various earlier time points). The invention can also produce an easy to read “running record” or “commentary” which summarizes some of the high points of the recent worker's progress. This later summary is termed “edit stream data”. The invention can then transmit either the detailed edit history data, or the more summarized event stream data, to the supervisor for evaluation as requested. Other invention functions will also be discussed.

### BRIEF DESCRIPTION OF THE DRAWINGS

FIG. 1A shows an overview of the invention's server system, here interacting with one or more workers and supervisors using various client computerized devices.

FIG. 1B shows a flow diagram for typical editing of a document.

FIG. 2 shows a flow diagram for typical server-side information request functionality.

FIG. 3 shows a flow diagram for typical server-side edit or revert functionality.

FIG. 4 shows a flow diagram for a typical history graph editor interaction.

FIG. 5 shows a development environment which contains a method of selecting files, editor controls to edit those files and a time based plot containing the edit history of the file.

FIG. 6 shows an event feed associated with a particular project.

FIG. 7 shows a zoomed in view of an embodiment of a history graph.

FIG. 8 shows a close up of an event stream example.

### DETAILED DESCRIPTION OF THE INVENTION

A server in this context is defined as, a computerized device with a networking device capable of communicating with a plurality of clients, a storage device (e.g. a database), and sufficient processing capability so as to be capable of doing the processing described in this invention.

A client in this context is defined as, a computerized device that is equipped with a networking device capable of communicating with the server, a processing (e.g. at least one microprocessor) device, and sufficient user interface equipment to allow the machine to both communicate effectively with the user and to receive the user interaction this invention requires.

A document or file which are often used interchangeably in this context, are defined as a named collection of information, in the form of text, programs, graphics, etc., usually held on a permanent storage device such as a magnetic disk, solid state memory, or other data storage device.

A project in this context is defined as a named collection of directories, with each directory being able to contain other directories or files. A project can also contain metadata, here defined as information that describes the state of the project, such as to do list, descriptions, permissions, etc. This data is also usually held on a permanent storage device such as a magnetic disk or other electronic data storage medium.

A control in this context is defined as a software subsystem that includes a user interface that is visually or programmatically separable or reusable from the rest of the program.

A link in this context is defined as a text or graphic item that initiates a different view when the user selects it by clicking on it with the mouse, or by some other means.

The following description sets forth numerous specific configurations, parameters, and the like. It should be recognized, however, that such description is not intended as a limitation on the scope of the present invention, but is instead provided as a description of exemplary embodiments.

The embodiments described herein are directed to methods and systems for creating a development environment that provides more complete work product transparency over prior art. This capability gives a supervisor the ability to quickly assess the productivity of one or more workers in developing or updating a document or project.

As previously discussed, in one embodiment, the invention may be a method of monitoring worker production or modification of electronic documents. The method will generally comprise creating a server based electronic document development environment comprising at least one network server, the invention's work product transparency software, and at least one database. Often the network server is an internet web server, and the network is the internet.

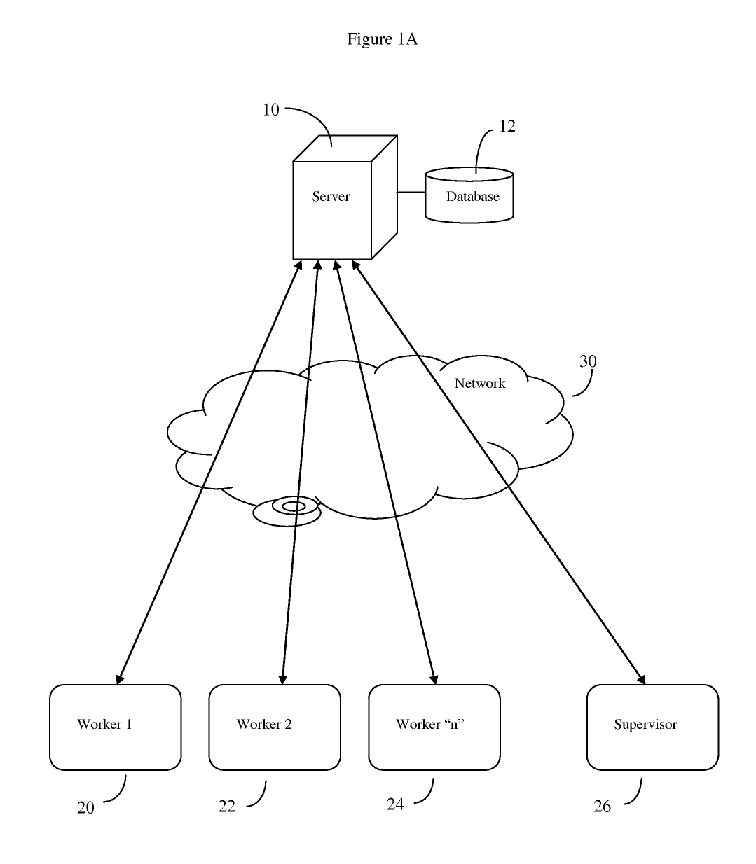

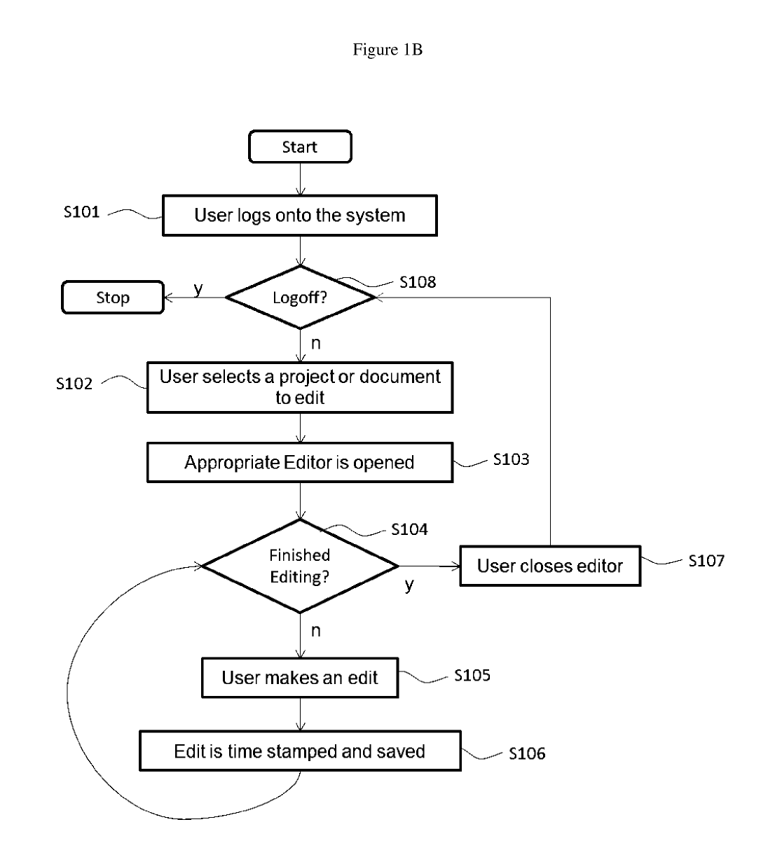

FIG. 1A shows an example of the computer hardware environment in which the invention's software products (e.g. the worker transparency software) and methods will typically operate. Here server 10 is connected to a database 12, which contains the various work files and electronic documents. This server 10 is also connected to various client computerized devices 20, 22, 24, 26 by a network connection, such as the internet 30. Thus workers 1, 2 . . . up to worker “n” may perform their work using various networked client computerized devices (e.g. desktop computers, laptop computers, tablet computers, smartphones, and the like).

One or more supervisors 26 may also receive work data, such as edit history data and event stream history data (to be discussed) using such client computerized devices as well. Note again that, as previously discussed, the terms “worker” and “supervisor” are used as simple nomenclature to illustrate what that particular individual's current interests are—i.e. to work on documents, or to see what other workers have done or are doing on documents. These terms thus may also be used to designate a purely collaborative environment, and are not intended to be limited to any particular employer/employee relationship or actual management reporting relationship.

The server 10 will typically comprise one or more computer processors, often x86, ARM, MIPS, or other equivalent processor, either single or multiple cores as desired. The server will additionally comprise memory, usually an operating system such as Linux, UNIX, Windows Server and the like, as well as ancillary support software such as Apache web servers or equivalent, database management software (e.g. MySQL or equivalent), scripting software, and the like. Normally the invention's work product transparency software will run in this environment, and may interact with these various software components.

As previously discussed, the database 12 will have at least one work file or project file. The project files can be many things, including, project directory information structures, to do lists, permission information, naming information, developer information, owner information, project related instructions, status updates, version supplements, project related comments and discussions. The files can include software code, code development and version tracking systems, word processor files, computer CAD (computer aided design) files, spreadsheets, project databases, video or image editors, or essentially any electronic record suitable for storing work product data.

In the invention's method, there will also be at least a one worker (e.g. 20, 22, 24) running a client computerized device that is capable of establishing a network connection with said server. This worker will also have identification data to distinguish the worker. This worker identification data may come in various forms, such as usernames and passwords, challenge questions, worker biometric information (e.g. fingerprint scans, facial recognition, voice recognition, eye (retinal, iris recognition) and the like). In many embodiments, the system will require worker authentication when the worker logs in to the server, and may deny access to unauthorized workers.

The worker will use his or her client computerized device 20, 22, 24 to connect and login to the server 10. After this initial step, the worker will then begin remotely editing various project file(s), usually at least initially stored on database 12, using his or her client computerized device. This editing can be done in various ways. In one embodiment, the user may do all editing within a web browser, and the client computerized device 20, 22, 24 may essentially act as a dumb terminal for the server 10. A dumb terminal in this context is defined as a display device that does limited processing; instead relying on a remote processing device to send it display data. In other embodiments, much or all of the editing may be done on software programs running on the client computerized device 20, 22, 24, such as word processing programs, software code development programs, video or image editor programs, CAD programs, and the like. Here, for example standard editor software programs capable of accepting plug-in software modules may be useful. In this embodiment, at least the client portion of the invention's work transparency software may be implemented in a plug-in software module. This allows the worker to perform his everyday tasks using programs that he is already proficient in, while at the same time making the task of the supervisor to monitor this work much easier.

Whichever editor is used (web browser or plug-in to a more dedicated editor), the invention's work product transparency software, running largely on the server 10, will perform the steps of: a): receiving edit operation data from the client computerized device; and b): saving this edit data along with an edit timestamp on the server, along with the workers particular identification data. The combination of edit operation data, user identification and timestamp information will hereafter be referred to as: “edit history data”.

Although the edit timestamp can be applied by the client computerized device, for higher security, it is often preferable to use the server to apply the timestamp to the edit data, often immediately or nearly immediately after this edit data arrives over the network.

Once this edit data is received on the server, it can then be used in various ways. As an example, either automatically (e.g. every day, upon various preset milestones, or other criteria), or alternatively upon receiving a query from one or more supervisors of the worker(s), the invention's work transparency software can retrieve the edit history data and perform various types of analysis on this data.

Because work projects can often span a considerable period of time, in many embodiments, it will be useful to allow the supervisor to enter in the time periods of interest for the data analysis. Additionally, because projects may contain many modules and many workers, software filtering algorithms, methods, or mechanisms are needed to prevent the supervisor from being bombarded with too much data that is not of interest. To facilitate such information overload, the system will often allow a supervisor to either set up a “white list” of projects, files, workers or event types that the supervisor wishes to monitor, and/or a “black list” of projects, files, workers or event types that the supervisor does not wish to monitor. The invention will also allow the supervisor to set time periods, such as beginning or ending dates, to further filter the data.

The edit history data, which in some embodiments may contain a very detailed log of all of the edits or changes to the various documents, can be analyzed by various methods. In some embodiments, simple statistical analysis, such as the time that each worker spends on each file or project may be of interest. In other embodiments, various formulas and algorithms designed to monitor worker productivity may be used. These can be standard statistical analysis methods (e.g. average times between edits, most common type of edit, average number of corrections, complexity of the edits, type of edit (e.g. changes to comments or changes to code or CAD drawings), and the like). Due to the large amount of edit history data, often various graphical methods of presenting the data, such as a time based graph showing the number of edits during a selected time period may be of interest.

In other embodiments, a supervisor may want to use the edit history data to reproduce a project document or file as it was during an earlier point in time. This reproduction can be a simple on on-screen window showing a portion of a one or more documents as they were at an earlier point in time. The reproduction can also be more complex, such as providing a complete hyperlinked multi-layered document structure allowing the supervisor to click and see the progression of the one or more documents of interest over time. The reproduction can also allow earlier stages of the document to be printed out, and transferred as needed. Indeed in some embodiments, with proper protections, the entire state of a work project can be reverted back to an earlier state in time.

To do these various types of earlier stage reproductions, the supervisor may input the desired time period into the system, and the work transparency software can then use the edit history data and a record of an earlier state of the data contained in the relevant project file(s) to reproduce some or all of said electronic documents as they were at the selected time period.

As previously discussed, however, often the supervisor may simply wish to get an overall summary of the work that has been done during a particular period of time or particular document editing session. To do this, in an alternative embodiment, the supervisor may, often by using a supervisor customized algorithm, direct the invention's work transparency software to produce more concise summaries of the edit history data. These more concise summaries are here termed “event stream data”.

Event stream data often consists of a variety of events that are selected to be of particular interest to the supervisor. For example, event stream data may be created by analyzing the edit history data for one or more of the following events, such as file movement commands, new file commands, open file commands, close file commands, deleting file commands, adding new worker commands, deleting worker commands, to do list commands, bug report file edits, number of edits between the time a file was opened and closed, number of edits between the time a file was opened and the time the edit history data was analyzed, file commenting edits, file version updating commands, and file renaming commands.

### Specific Examples

In one embodiment of the invention, the invention allows a manager or supervisor to add one or more workers to a project that he wants work done on. Here workers must first log into the system. These workers may then, for example, use a web based development environment to select a file they have been directed to modify. To facilitate this process, the invention's work environment may include a number of different types of editors depending on the type of file to be modified, or alternatively the worker may use his or her own editor, so long as this editor contains a plug-in that can deliver the required information back to the server.

The user can then make edits to the document using his computerized device 20, 22, 24. Each of these edits is in turn sent over a network 30 to a server 10 that takes the edit and saves it in database 12. This edit data will be saved with metadata that includes a timestamp taken at the time the edit was received, and the worker identification number of the worker that made the edit. This process can be done iteratively on one or multiple files. Project information can also be edited in this development environment. Project information can include directory information structures, to do lists, permission information, naming information, developer information, owner information, project related instructions, status updates, version supplements, and project related comments and discussions.

At a later time, a supervisor/manager 26 can now look and see a summary of the work done by this user. This summary can be presented in various ways. One convenient way is to present a time based plot that allows the supervisor to determine when the edits were made. To drill down further into this information, the supervisor/manager can also click on the time based plot at any point, and be presented with a reproduction that shows what that document or project looked like at that point in time. The system may also provide a summary of the recent major edits in the form of an event stream for the supervisor/manager's perusal. The supervisor/manager can also open up an editor and use the history graph to see one or more documents at any point in its history. The manager gets status updates as to when files are being edited so he knows which editor to look at.

FIG. 1B shows a flow diagram of one possible embodiment of the invention. It is not intended to show all possible states and transitions, but instead to give a simple example. In diagrams 1B to 5, since the diagrams are showing various operations performed by the invention's worker transparency software, the various numbers will have an “S” prefix to emphasize that these are software related functions.

Before using the system, a user (e.g. worker or supervisor) must first logon S101. Logging on to the system is a method of letting the computer system knows which user (worker/supervisor) is on for the given session. This is normally achieved by having the user type in their username and password into a form and submitting this information to the server 10 for authentication.

By authentication, it is meant that the system determines if a user is actually is who they claim to be. In some embodiments, the actual password is not sent, but rather mathematical proxies are transferred to insure a secure and confidential authentication method. This is important because if the password falls into the wrong hands, then they will be able to foil this authentication method. Other authentication methods may include a series of predetermined questions that only the user knows the answers to. Biometric identification, such as fingerprint and iris readers may also be used for secure authentication. The particular type of authentication is not important for this invention. What is important is that the system knows with reasonable certainty which person is currently using the computer system.

After any operation, the user has the option of logging off the system S108. This ends their session so that they cannot use the system without logging on again in the future For the system to know which file or project is being modified; the user must have a method of selecting a project or document S102. Normally a list of projects that are selectable is provided. For a document, often a tree view is utilized. Although useful, this control option does not always have to be provided by the invention's software. Often the control may be a third party plug in, or operating system call. The information that is derived from this control is then used by the system to determine what to edit.

The system uses the information from S102 to open up an appropriate editor control S103 so that the user can start editing the project or document of interest. Again, this editor can be provided by server 10, or alternatively a plug-in to an editor residing on the worker's client computerized device 20, 22, 24 can be activated.

After any edit S104, the user may close the editor he is using S107, and the system may return to its original login state. Alternatively the user may open up another document or project and modify that one at the same time. Here, for simplicity, these examples and diagrams shows only one project or document open at a time.

The types of edits S105 that are available to the user depend on the document type and the current state of the document. Independent of what type of edit is made, after the edit is made; the edit is time stamped and saved S106. This operation can occur locally on the worker's client device 20, 22, 24, or the edit could be sent to the server 10 or other device to be time stamped and saved.

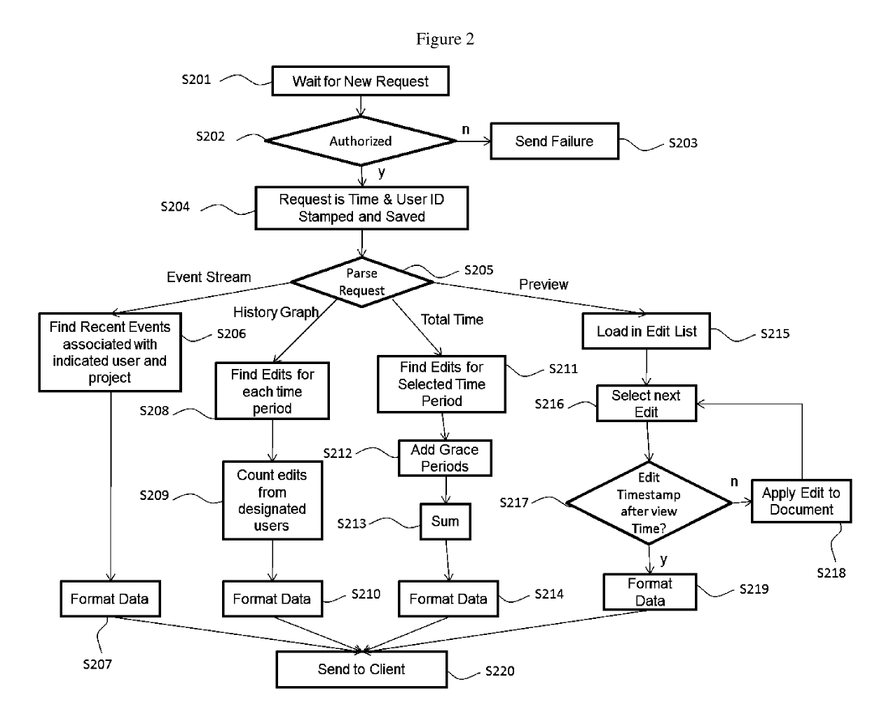

FIG. 2 shows a flow diagram of a server-side implementation of the invention, in which much of the worker transparency software is residing on server 10. Note, however, that in other embodiments, more of the worker transparency software may also reside on the client machine 20, 22, 24. This flow diagram focuses on information retrieval from the already saved edit information. For simplicity purposes, it does not show all possible states or transitions.

Note that often it will be preferably to centrally locate the edit data, for example on database 12. Other embodiments, in which the edit data, although possible are more complex, and thus for simplicity, the centrally located edit data embodiment is shown in these examples.

The server 10 may often be event driven. In these embodiments, it is necessary for the server to wait for a request S201 from the client before processing the request.

Before the server will process a request, it needs to know that the user is properly authorized S202. This authorization process may be done, for example, by looking up the username and passphrase accompanying the request in a database to make sure that a) the user exists, b) the user's passphrase is correct, and c) the user has the permission level necessary to process the request. In a preferred embodiment, this information may be transmitted over network 30 using a secure connection method. If the request is not authorized, the server sends a failure notice S203 to the client.

Once the request has been authorized; it is time and user stamped S204 so that the system knows when and who requested the information. Here the request summary is saved in a database along with the user who requested it, and the time the request was received. This type of information is also useful for the event stream data, to be discussed.

The system then parses the request S205. In this embodiment there are four types of requests, Event Steam, History Graph, Total Time and Preview. Each request can also contain other pertinent request information.

If the request is for the Event Stream data, then the server finds various events associated with the user or project S206.

The server formats each item in S207. The information for each item may include the user that initiated the event, the time the event occurred, which project the event is associated with, and a description of the item.

If the request is for a History Graph, then the server must determine, given a start time, an end time, and a number of periods, the number of edits in each period S208. To accomplish this, the server 10 may load the edit list and iterate over each of the edits to determine if their associated timestamp indicates they occurred in the range of any of the periods of interest. If it did, a value associated with that period is incremented.

S209 indicates that another possible filter for this type graph is the ability to filter the edits for a particular user. That is, if the edit was not initiated by that user, it is not counted towards the total. Before sending the data back to the client, it is often advisable or necessary to format the date in a condensed manor S210.

If the request is for Total Worker Time, then the server must estimate the total time the worker has worked on a project or document, again usually given a particular time range. This process may start, for example, by finding all of the edits in the selected period for the requested worker S211. From these instantaneous points the system can then estimate the total time worked by adding a “grace” period S212 to the beginning and the end of each edit. Any overlap in grace periods is discarded, and the total time is summed up S213. Login timestamps and information request timestamps can also be used to supplement the edit timestamp information and provide an improved estimate of time worked. The data is formatted S214 before being sent to the client.

If the request is to Preview, then the server must reconstruct the document or project to the indicated time. One method to accomplish this is to start the document or project in an empty or default state. Next, the server loads the edit list into memory S215. Then the server selects each edit in the edit list starting with the first S216. Then in S217 the timestamp associated with the edit is looked at to determine if the edit took place after the time indicated in the request. If it took place after the time, then the reconstruction is finished. If not, then we apply the edit S218 to the document in a standard fashion and continue in the loop. After the document has been reconstructed, it is formatted S219 before being sent back to the client.

The result from the request is sent to the client as shown in S220.

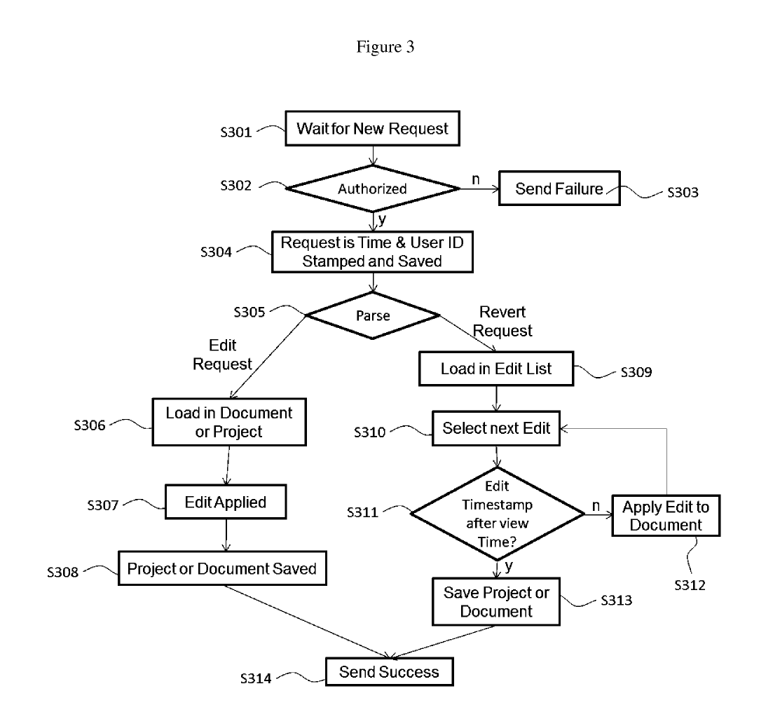

FIG. 3 indicates a possible flow diagram of a server side embodiment of the invention. Here the user opens up a document in an editor. As the user makes edits to the document, these edits are immediately sent to server 10. The server saves the edits along with metadata that includes the timestamp of when the edit was received, and who it was received from.

An edit, in this context, refers to a change to the document that is localized in time. To a user, an edit is may often be considered to be a logically inseparable “atomic” operation. For example, an edit can consist of no more than the addition of one symbol or one operation. In an editor, this could consist of adding a letter or word with the keyboard or a delete or paste operation. In a graphic editor it could consist of a single edit with the mouse or a single copy, filter operation, etc. Editors normally separate edits into these logical delineations, and a user can undo a single logical operation. If the editor has undo and redo operations, then the edits sent should, ideally, be the same as those used in the undo and redo operation.

In FIG. 3, S301, S302, and S303 are the same as in FIG. 2.

After the request has been authorized, the request is time and user ID stamped and saved to a storage device S304. Ideally, the timestamp should be taken immediately after the edit is made. This is because timestamps made after another operation, such as a save, merge or check-in, lose their statistical significance. In addition, the edit operation should ideally be for every logical edit the user makes. Thus if edits are skipped, or are grouped, then the statistical significance is degraded or lost altogether.

In a preferred embodiment, the timestamp is made by the trusted server 10. This is preferable, because this avoids the problems that could potentially result if an unscrupulous worker alters his or her client computerized device 20, 22, 24 to forge when the edits took place.

The edit itself also needs to be saved, so that later the system can use it to revert to that particular time in the document or project's history (a “revert edit”).

The server must parse the edit S305, and determine if the edit is a typical edit or a revert edit.

If the edit is a normal (non-revert) edit on the document, then the server needs to load in the document or project if it is not already in memory S306, and apply the edit to the document in a typical fashion S307, then save it to a storage device S308.

If the edit is a revert edit, then the server must reconstruct the document to the time indicated in the revert request. One possible way to do this is to start the document in an empty or default state. Next, the server loads the edit list into memory S309. Then the server selects each edit in the edit list starting with the first S310. Then in S311 the timestamp associated with the edit is looked at to determine if the edit took place after the time indicated in the request. If it took place after the time, then the reconstruction is finished. If not, then we apply the edit S312 to the document in a standard fashion and continue in the loop. If the system is finished with the reconstruction, then the reconstructed project or document should be saved S313.

Finally, after the server has finished a successful request, it may send to the client a response indicating success S314. The client software will then know that its request was successful.

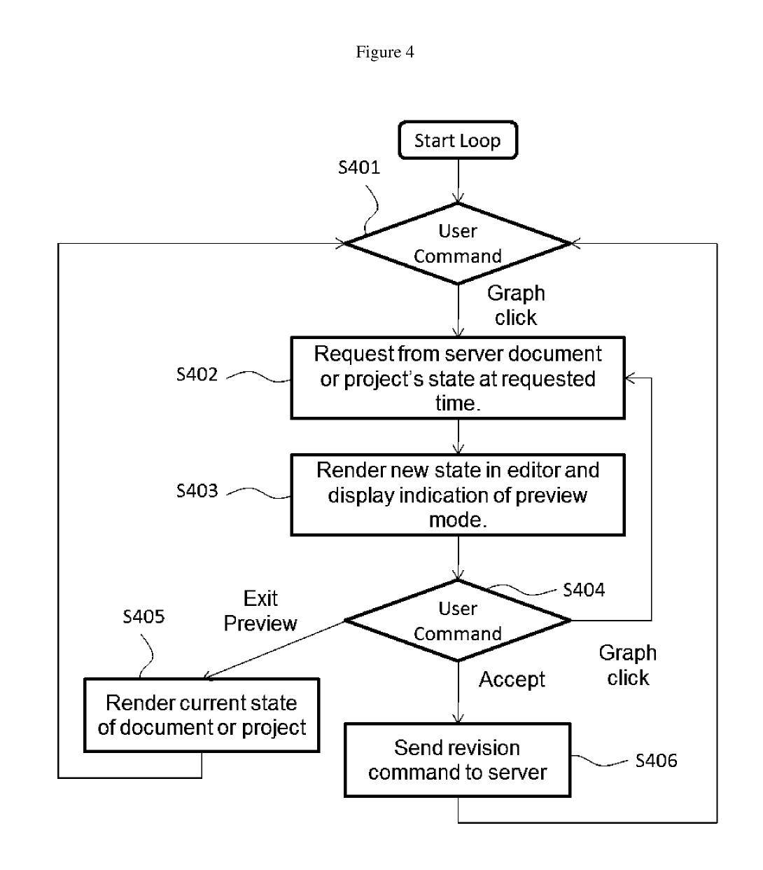

The invention can include a preview capability, which allows a user or manager to view a document at any time in its past. In one embodiment, when the user clicks on a particular time in this plot, the editor can send a request to the server 10 to retrieve what the document looked like at the requested time. That document can be placed in the editor view, with an indication that what the user is seeing is not the current document but a historical state. This capability requires the server to perform the software flow diagram shown in FIG. 4.

In terms of the user interface, the invention can include the ability to revert the document to this state by providing a “revert to” option for the worker or supervisor to click on.

In the simplified embodiment shown in FIG. 4, only the options S401 that are invoked after a user has clicked on the history graph are shown. Note that there are usually many other commands that the user can issue as well.

Once the history graph is clicked on, the client machine sends a request to the server S402 to request the document's state at the time corresponding to the time the user indicated. This requested time period is sent along with the request.

After the server sends the requested document, the client renders the document in the same place the old document was S403. An indication that the editor is in preview mode will often be added so that the user knows what they are looking at.

When the system is in preview mode, the user can look at the document in the same way he could in normal mode S404. The user has the option to exit the current preview mode, either by clicking on a button designated as a preview exit, by closing the editor or project, or by initiating a new preview mode by clicking on the history graph. The user can also choose to issue a revert command on this document or project to revert it back to this earlier state either by clicking on a button with this designation, or by making an edit on the document or project, or possibly by some other method.

If the user chooses to exit preview mode S405, then the editor needs to re-render to change back to the current document. In this particular example, the document hasn't been changed at all, and the user has used this mode purely to see what the document or project looked like at a particular time in its history.

If the user chooses to revert the document back to the time the user previously indicated when he or she clicking on the history graph S406, then this “revert” edit is sent to the server 10 and the mode is changed back to normal editing mode.

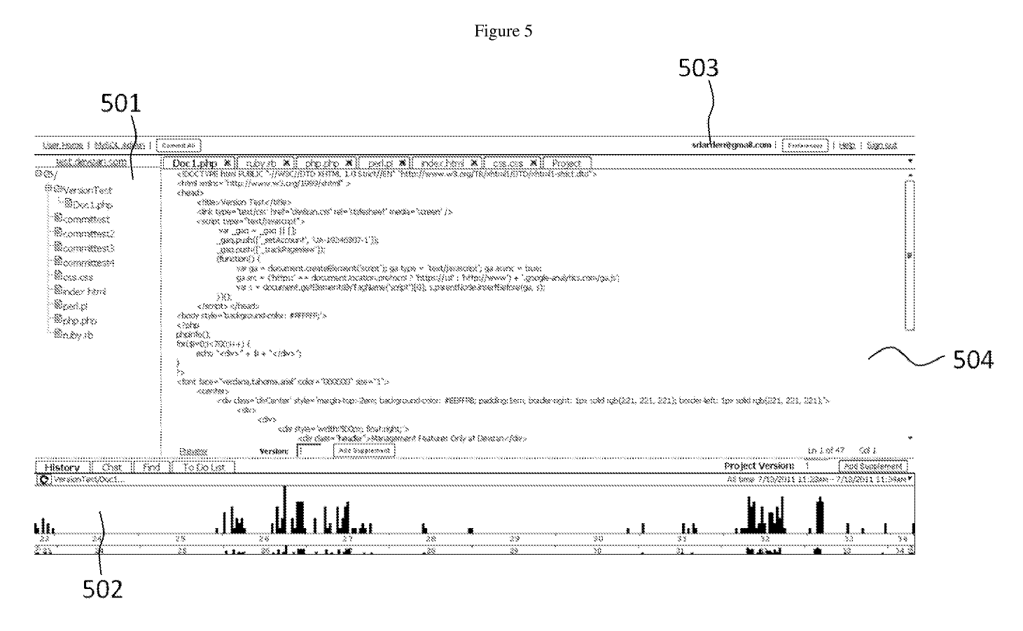

FIG. 5 shows a screenshot of a development environment, with a 501 file tree control for selecting which file to open, creating new files or directories, moving files or directories or deleting files or directories.

When a user opens a file for editing, an editor control opens with the file contents in it as in 504. The editor control configuration can depend on the file type, and the editor could be a simple text editor, a source code editor as shown, a graphics editor, a video editor, an audio editor, a binary editor, even an FTP (File Transfer Protocol) system that uploads new files or replaces or appends one file for another. Each of these editors must be able to send to a server the edit operation that has been made to the file after the user makes it. Again, often standard editors may be modified to do this by use of appropriate plug-ins. Alternatively, customized editors that provide this edit information to server 10 may be used.

In some embodiments, the development environment can include a 502 time based plot that can allow the user or a manager/owner to view the number of edits that have been made in a particular period in time shown in this embodiment in the y axis and time in the x-axis. This embodiment shows a bar plot, but other embodiments could present this data with other types of plots such as a line plot. In this embodiment, the height of the bar indicates the number of edits that were made to the document in the time period that bar represents. This plot is associated with the document that is currently being displayed. A similar plot can exist for every file in a project, as well as for the project as a whole.

The text shown in 503 gives an indication that the user is logged on and allows a user to signoff, which is another way of saying logoff.

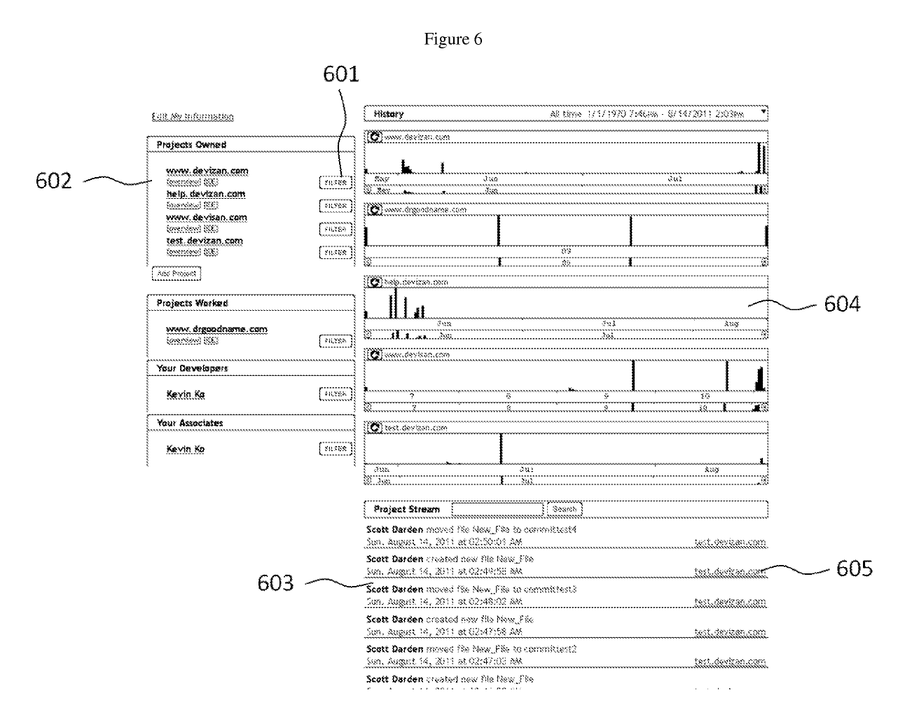

FIG. 6 is an embodiment of a control console that allows a manager to keep track of the work done on one or more projects by one or more teams. Using this console 602, a manager can add or remove workers, add or remove projects, select projects to edit and see an event feed associated with one or more projects. This console can also show a number of time-based plots 604 describing projects the user or manager is associated with. 603 shows an event stream or event feed (in this context used interchangeably). This is a stream of important events that reports the latest happenings associated with a user or project. In this embodiment, each item in the feed shows the project the item is associated with, which user (worker) is responsible for the event, a description of the event and an indication of when the event took place relative to the current time. It is also possible to filter (e.g. use a blacklist or whitelist) the information in the event stream 603 and time based plots 604 using a control as shown in 601 so that only items pertinent to a supervisor's particular project of interest are shown.

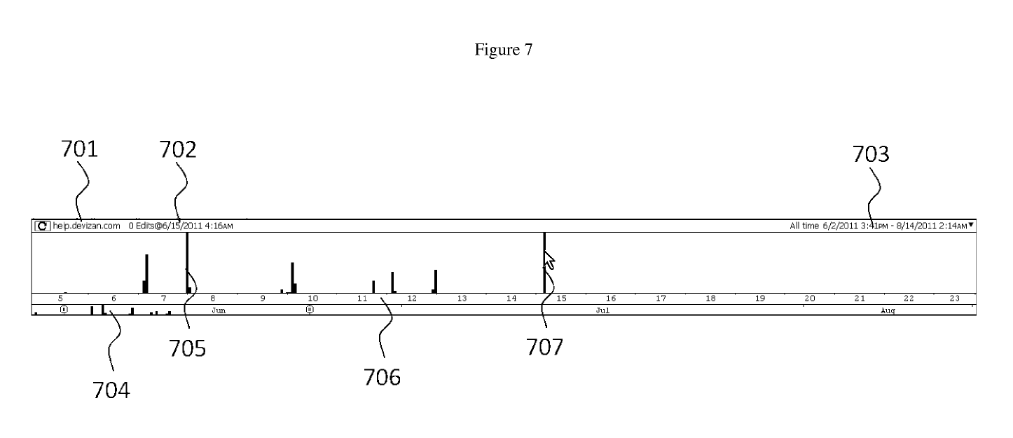

FIG. 7 shows a screenshot showing that the supervisor can also have an option to show only the edits of a particular worker, a group of workers or of all workers. Other embodiments could include plots that show different worker's edits in a different color.

A label 701 showing the associated project or document that the graph is associated with can be included in the control. If it is a project graph, then all edits to the project and all associated documents may be included in the graph. If the graph is associated with a particular document, then only those edits done on that particular document are shown.

A status pane 702 that shows details of the currently selected time period can be included in the plot control. This pane would normally indicate in text form the number of edits that were performed in the time period, as well as what time is associated with the time period. In this embodiment, the currently selected time period is wherever the mouse is currently located on the graph as indicated in 707.

In this embodiment, there is no y-axis showing the relation of the height of the time periods to the number of edits they indicate. Rather, the height of each time period is directly related to the number of edits that occurred during that time period, which is shown in 705. However a vertical axis could be included to indicate to the user the scale of the graph. An x-axis time scale is shown in 706 so the user knows which time period corresponds to which bars.

The plot can contain one or more methods of selecting the total time period to view. This method could be a slider 704, or it could be some other form of selection, such as a control where a start and stop date and time are entered 703.

Alternatively, FIG. 5 contains an embodiment that includes a second method of selecting a desired the time range to view. This embodiment includes options for time ranges of potentially high interest to the supervisor, such as the last day, work week, current month, and the last month. The system can also allow the supervisor to enter a custom time range.

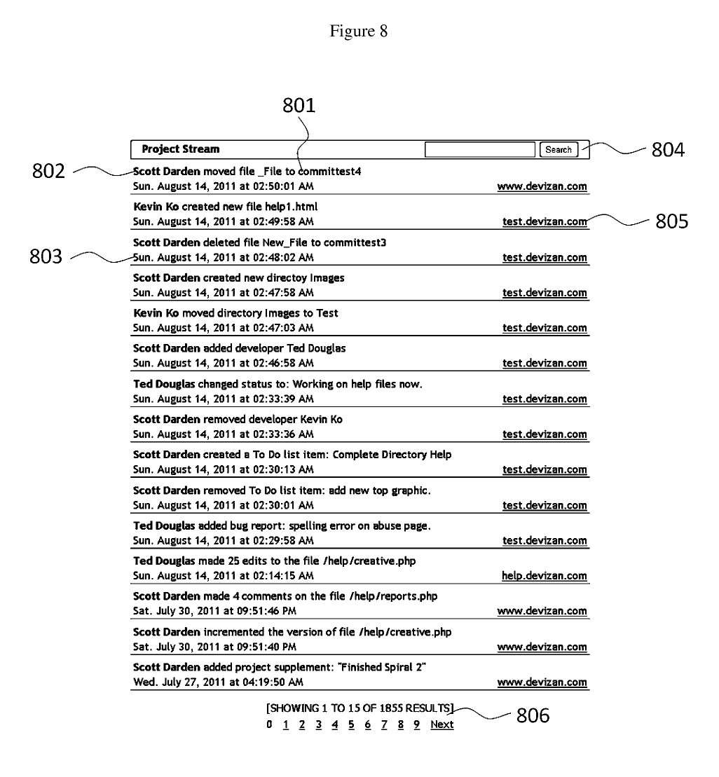

FIG. 8 shows an embodiment of an event stream. Items in the event stream are displayed chronologically with newer events closer to the top.

Each project item can include a description 801 of the activity that was performed. Such activities could include project status updates, version increment information added, supplemental information added, comments added, files created/deleted/moved, directories created/deleted/moved, files modified (multiple edits can be condensed into one item), project to do list items updated/added/deleted, bug reports created/deleted/modified, and developers added/deleted.

Each item in the stream can include the user (worker) name 802 or a user designation identifying who made the edit. If the worker is not known, or the event was a system event, then this can be shown instead. This name can link to a page associated with the worker.

Each item in the stream can include a time 803 or a time range that indicates when the event took place.

The event stream can include a method 804 to filter the event stream for a given word, words or a phrase. Thus for example, a supervisor interested only in code changes can instruct the event stream to filter out (blacklist) edits to comments or other documentation, and vice versa. As another example, a supervisor interested in tracking bug fixes can instruct the event stream to preferentially show (whitelist) bug related edits, and so on.

A project can be indicated as part of an item in the stream 805. This project is associated with the activity, and can link to another page showing information regarding that project.

At the bottom of the event stream control is often a navigational control 806, so that the user can see older events. There are other possible ways to allow the user (supervisor) to see older items as well, such as having a scroll control that allows them to move the page down further.

1. A method of monitoring worker production or modification of electronic documents, said method comprising:
Creating a server based development environment comprising at least one network server, work product transparency software, and least one database;
Said database having at least one project file;
Obtaining at least one worker with a client computerized device capable of establishing a network connection with said server;
Said worker having worker identification data;
Wherein, when said at least one worker uses said client computerized device to establish a network connection with said server, login to said server, and begin remotely editing said at least one project file from said client computerized device using an editor, said work product transparency software performs the steps of:
a: receiving edit data from said client computerized device;
b: saving said edit data along with an edit timestamp on said server, and said worker's identification data, thereby producing edit history data;
Wherein, either automatically or upon receiving a query from a supervisor of said at least one worker, said work transparency software additionally performs the steps of:
1: retrieving said edit history data;
2: analyzing said edit history data and/or producing event stream data; and
3: transmitting said edit history data or event stream data to said supervisior.

2. The method of claim 1, further authenticating said at least one worker during login, and denying access to unauthorized workers.

3. The method of claim 2, wherein said authenticating is done using authentication methods that are selected from usernames and passwords, challenge questions, and worker biometric information.

4. The method of claim 1, wherein said edit timestamp is supplied by said server when said edit data is received.

5. The method of claim 1, wherein the work transparency software analysis produces summary statistics of said edit history data.

6. The method of claim 1, wherein, upon input of a selected time period by said supervisor, the work transparency software analysis produces a time based graph showing the number of edits during a selected time period.

7. The method of claim 1, wherein upon input of a selected time period by said supervisor, the work transparency software analysis uses said edit history data and a record of an earlier state of data contained said at least one project file to reproduce some or all of said electronic documents as they were at said selected time period.

8. The method of claim 1, wherein said project file additionally contains project information comprising one or more items selected from the group consisting of directory information structures, to do lists, permission information, naming information, developer information, owner information, project related instructions, status updates, version supplements, project related comments and discussions.

9. The method of claim 1, wherein analyzing said edit history data is done by a worker or supervisor customized algorithm, thereby producing worker or supervisor customized event stream data.

10. The method of claim 9, wherein said worker or supervisor customized algorithm is set to only generate or transmit whitelisted event stream data, or to fail to generate or block transmission of blacklisted event stream history data.

11. The method of claim 1, wherein analyzing said edit history data is done by an algorithm using one or more analysis methods selected from the group consisting of file movement commands, new file commands, open file commands, close file commands, deleting file commands, adding new worker commands, deleting worker commands, to do list commands, bug report file edits, number of edits between the time a file was opened and closed, number of edits between the time a file was opened and the time the edit history data was analyzed, file commenting edits, file version updating commands, and file renaming commands.

12. The method of claim 1, wherein said server is an internet web server, said network is the internet.

13. The method of claim 12, wherein said editor runs on a web browser running on said client computerized device.

14. The method of claim 12, wherein said editor is an editor software program running on said client computerized device, said editor software program accepts plug-in software modules, and said editor software program transmits said edit data to said server using a plug in software module.

15. The method of claim 14, wherein said editor software program is a word processing program, a software code development program, an image editor program, a video editor program, or a CAD program.

16. A method of monitoring worker production or modification of electronic documents, said method comprising:
Creating a server based development environment comprising at least one network server, work product transparency software, and least one database;
Said database having at least one project file;
Obtaining at least one worker with a client computerized device capable of establishing a network connection with said server;
Said worker having worker identification data;
Wherein, when said at least one worker uses said client computerized device to establish a network connection with said server, login to said server, and begin remotely editing said at least one project file from said client computerized device using an editor, said work product transparency software performs the steps of:
a: receiving edit data from said client computerized device;
b: saving said edit data along with an edit timestamp on said server, and said worker's identification data, thereby producing edit history data;
wherein said edit timestamp is supplied by said server when said edit data is received;
Wherein, upon receiving a query from a supervisor of said at least one worker, said work transparency software additionally performs the steps of:
1: retrieving said edit history data;
2: analyzing said edit history data and/or producing event stream data;
3: transmitting said edit history data or said event stream data to said supervisor;
wherein said server is an internet web server, said network is the internet;
said server authenticates said at least one worker during login, and denies access to unauthorized workers; and
wherein authentication methods are selected from usernames and passwords, challenge questions, and worker biometric information.

17. The method of claim 16, wherein the work transparency software analysis produces summary statistics of said edit history data.

18. The method of claim 16, wherein, upon input of a selected time period by said supervisor, the work transparency software analysis produces a time based graph showing the number of edits during a selected time period.

19. The method of claim 16, wherein upon input of a selected time period by said supervisor, the work transparency software analysis uses said edit history data and a record of an earlier state of data contained said at least one project file to reproduce some or all of said electronic documents as they were at said selected time period.

20. The method of claim 16, wherein said editor runs on a web browser running on said client computerized device.

21. The method of claim 16, wherein said editor is an editor software program running on said client computerized device, said editor software program accepts plug-in software modules, and said editor software program transmits said edit data to said server using a plug in software module.

22. The method of claim 16, wherein said editor software program is a word processing program, a software code development program, an image editor program, a video editor program, or a CAD program.

23. The method of claim 16, wherein analyzing said edit history data is done by a worker or supervisor customized algorithm, thereby producing worker or supervisor customized event stream data.

24. The method of claim 23, wherein said worker or supervisor customized algorithm is set to only generate or transmit whitelisted event stream data, or to fail to generate or block transmission of blacklisted event stream history data.

25. The method of claim 16, wherein analyzing said edit history data is done by an algorithm using one or more analysis methods selected from the group consisting of file movement commands, new file commands, open file commands, close file commands, deleting file commands, adding new worker commands, deleting worker commands, to do list commands, bug report file edits, number of edits between the time a file was opened and closed, number of edits between the time a file was opened and the time the edit history data was analyzed, file commenting edits, file version updating commands, and file renaming commands.

26. A method of monitoring worker production or modification of electronic documents, said method comprising:
Creating a server based development environment comprising at least one network server, work product transparency software, and least one database;
Said database having at least one project file;
Obtaining at least one worker with a client computerized device capable of establishing a network connection with said server;
Said worker having worker identification data;
Wherein, when said at least one worker uses said client computerized device to establish a network connection with said server, login to said server, and begin remotely editing said at least one project file from said client computerized device using an editor, said work product transparency software performs the steps of:
a: receiving edit data from said client computerized device;
b: saving said edit data along with an edit timestamp on said server, and said worker's identification data, thereby producing edit history data;
wherein said edit timestamp is supplied by said server when said edit data is received;
Wherein, upon receiving a query from a supervisor of said at least one worker, said work transparency software additionally performs the steps of:
1: retrieving said edit history data;
2: analyzing said edit history data and/or producing event stream data;
3: transmitting said edit history data or said event stream data to said supervisor;
wherein said server is an internet web server, said network is the internet;
said server authenticates said at least one worker during login, and denies access to unauthorized workers; and
wherein authentication methods are selected from usernames and passwords, challenge questions, and worker biometric information;
wherein analyzing said edit history data is done by a worker or supervisor customized algorithm, thereby producing worker or supervisor customized event stream data;
wherein said worker or supervisor customized algorithm is set to only generate or transmit whitelisted event stream data, or to fail to generate or block transmission of blacklisted event stream history data; and
wherein analyzing said edit history data is done by an algorithm using one or more analysis methods selected from the group consisting of file movement commands, new file commands, open file commands, close file commands, deleting file commands, adding new worker commands, deleting worker commands, to do list commands, bug report file edits, number of edits between the time a file was opened and closed, number of edits between the time a file was opened and the time the edit history data was analyzed, file commenting edits, file version updating commands, and file renaming commands.
